(19) United States
(12) Patent Application Publication
(10) Pub. No.: US 2007/0055693 A1
(43) Pub. Date: Mar. 8, 2007

(54) Data recovery method

(76) Inventors: Simon Galbraith, Cambridge (GB); Neil Davidson, Cambridge (GB)

Correspondence Address: UKITLAW.COM, 28, SILLWOOD ROAD, BRIGHTON, BN1-2LE, GB

(21) Appl. No.: 11/497,648

(22) Filed: Jul. 31, 2006

Related U.S. Application Data
(60) Provisional application No. 60/716,032, filed on Sep. 7, 2005.

(51) Int. Cl. G06F 17/00

(52) U.S. Cl. 707/103 R

(57) ABSTRACT

A method of ordering a plurality of database object scripts, the method comprising the steps of: parsing the plurality of object scripts to obtain dependency information representing dependencies between the associated objects; and analysing the dependency information to determine a sequence in which to execute the object scripts.

### CROSS-REFERENCE TO RELATED APPLICATIONS

This application claims the benefit of Provisional Patent Application Ser. No. 60/716,032 filed on 7 Sep. 2005.

### FEDERALLY SPONSORED RESEARCH

None.

### SEQUENCE LISTING

None.

### BACKGROUND

The present invention relates to database structures, relational databases and relational database servers. In particular, but not exclusively, the invention relates to object scripts within a database, and more particularly to determining a sequence in which object scripts should be executed by a database server so that a database server will be able to correctly recreate the database or a sub-section of the database. A database structure or schema is a collection of database objects, such as a set of tables, views, stored procedures and other objects. Each object is typically defined by a structured query language (SQL) code, or script, and the code defining an object will be referred to herein as an “object script”. SQL is a standard language allowing users of a database server to create objects by describing them with a script comprising a series of SQL statements, and to interact with a database, for example to query information or to obtain a particular view of a part of the database. A script can alternatively be created by programs without the use of a database server, or even manually.

Objects within a database may be inter-related such that one object depends on the information in another object. When a database structure (or schema), comprising a series of objects, is created, the objects may be defined partly in terms of dependency information, which describes the relationship an object has with other objects within the database. As an example, an object such as a view might depend on two table objects comprising information to be retrieved when the view is selected. The options for dependency within a relational database are varied: an object may depend on many other objects, and may have many objects dependent upon it, and dependencies can cascade through many levels, for example where object A is dependent on object B, which in turn is dependent on object C, which is in turn dependent on object D, and so on.

Once a database has been created, it can then be desirable to create a programmatical description such as an SQL script for the entire-database, or for a subset of objects within the database. This might be required in order to move or copy a database structure.

A database script comprises the scripts of all the objects in a database, ordered so that when the database server ‘runs’ the script the database will be recreated.

The SQL object script defining a dependent object within a relational database includes details of the dependency of the object. In addition, it is common for a database server/system to record such dependency information for all objects at the time when the objects are created. A database server traditionally calculates and stores dependency information every time an object is created, altered or deleted. Dependency information is typically stored in this way as metadata, which is created, updated, deleted or modified as objects are changed. This metadata can be accessed if a database structure needs to be regenerated. The stored dependency information can allow the objects to be scripted in an order such that dependencies can be preserved. For example, if a database structure includes an object A which depends on object B then B must generally be scripted before A so that A can properly be defined in terms of its dependency on B.

Conventional database systems suffer the disadvantage that metadata representing the dependencies of objects within a database can become incorrect and incomplete. This can occur for many different reasons such as bugs in the database server/system, deliberate restrictions of the levels of dependency that can be recorded (for speed-of-performance reasons) or the infeasibility of analytically determining dependencies at a given moment, due for example to changes having been made to objects in the database, or a circular set of dependencies (described further below).

A further shortcoming of present database systems is that because the metadata is created and recorded when objects are first created, it may not be possible to calculate all the dependency information at that time. For example, a stored procedure might be created to access a view that has not yet been defined. It may not always be feasible to update the metadata as each object is created, altered or removed because this involves analysing the dependencies of all of the database objects. In databases with large number of objects this would be prohibitively time consuming and would be likely to degrade the performance of the database.

Once the metadata describing object dependencies becomes incorrect it may be. impossible to correctly reproduce the database. For example, suppose there is an object A whose individual script specifies that it is dependent on object B, but whose metadata is missing this dependency information. It could then occur that on executing the scripts of the objects, object A's script could be executed by the server before object B's, and the dependency of A on B could then not be included in the script defining A because object B would not yet exist within the database. Thus, if object scripts are passed to the database server in the wrong order the database server would be attempting to create objects that depend on objects that do not yet exist, and this might cause the database to be incorrectly created.

A further problem with known database systems is that of circular dependencies. A circularity is said to occur when objects depend on each other, for example where an object C depends on an object D, and object D also depends on object C. In such a case, re-creating those objects is problematic because when the script of a first one of the objects C is executed, the other object D will not yet have been created and therefore the dependency of the first object C on the other object D cannot legitimately be included in the script for the first object C. It is likely that this would cause the recreation of the database structure to fail.

### SUMMARY

According to a first aspect of the present invention there is provided a method of ordering a plurality of database object scripts, the method comprising the steps of: parsing the plurality of object scripts to obtain dependency information representing dependencies between the associated objects; and analysing the dependency information to determine a sequence in which to execute the object scripts.

According to a second aspect of the present invention there is provided a method for creating a database, comprising: a step of ordering a plurality of database object scripts into a determined sequence, by a method as defined in any preceding claim; and a step of executing the object scripts in the determined sequence to create a database.

The determination preferably includes ordering each of the plurality of object scripts in accordance with their phases, as described below, for example using a node diagram.

The determined sequence may specify that object scripts defining objects which have no dependency on other objects are to be executed in a first stage.

Optionally, the analysing step can comprise creating a node diagram representing the dependency information.

The sequence in which to execute the object scripts may be determined using a leaf pruning algorithm.

The method may further comprise the step of: if the analysing step indicates that a circularity exists in the dependency information, determining which of the objects involved in the circularity has the fewest dependencies on objects outside the circularity; and removing dependencies on that object from other objects within the circularity.

### DRAWINGS

The present invention will now be described by way of example with reference to the accompanying drawings, in which:

FIG. 1 shows a typical object dependency relationship, or node diagram;

FIG. 2 shows a node diagram which includes a circular dependency;

FIG. 3 shows an embodiment of the present invention in which a circularity is removed;

FIG. 4 is a flow chart representing a process according to an embodiment of the present invention; and

FIG. 5 is a comparison of actual and recorded dependency information in a prior art database system.

### DETAILED DESCRIPTION

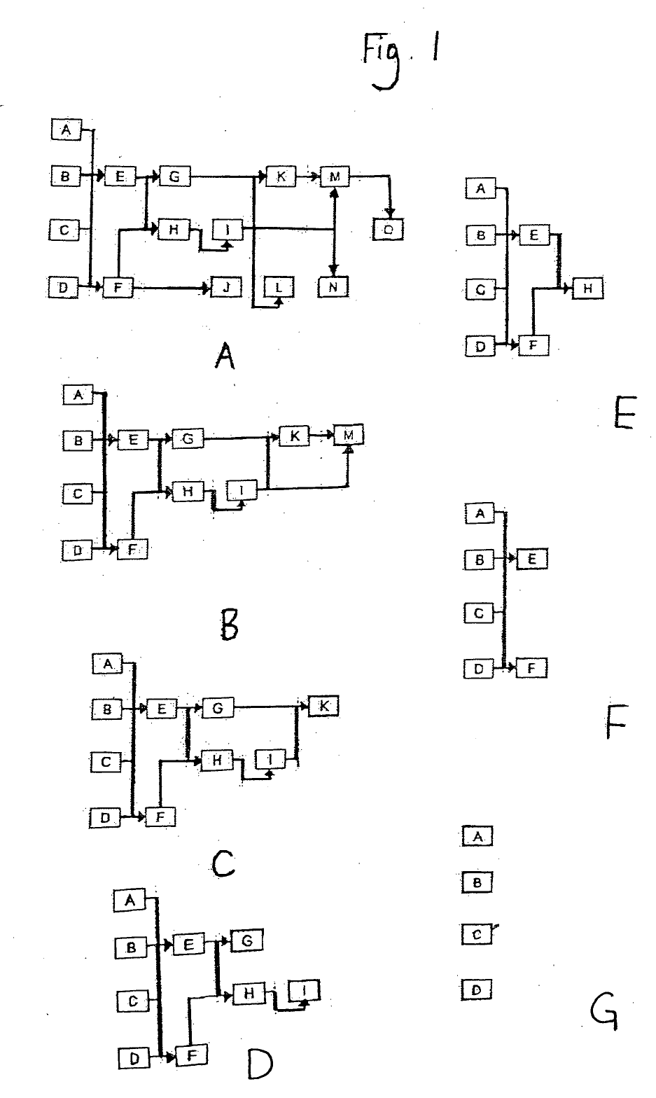

FIG. 1A shows schematically a series of related database objects A to O. Nodes are used to represent the objects and arrows indicate the directions of dependencies between them. For example, objects K and I are both dependent on object M; object M is dependent on object O; object O does not depend on any other objects. Objects K and I might, for example, be views. If this were the case the view I would require information from objects M and N, whereas the view K would require data from M only, although it can be seen that M is dependent on O.

In accordance with the present invention, this dependency information, and all the dependency information relating to the objects A to O shown in FIG. 1A, can be determined by parsing the scripts defining each of the objects. This requires analysing the code by which objects are defined to determine details of the database. The script language is examined to identify objects referred to in a script and to identify the relationships between the objects referred to. This is a clear improvement on previous systems, where the dependency information was stored separately from the object scripts, typically within the database server.

Parsing operations are well-known in the field of database systems. Parsers are used in database servers (such as Microsoft SQL servers) as part of the process of compiling scripts defining database objects (such as stored procedures) into code that can be executed by the server. There are parsers in the public domain for many types of SQL. Parsers for a specific language are typically built from a tool such as ANTLR (www.antlr.org) according to a grammar that describes the language to be parsed. Examples include grammars for Oracle SQL (http://www.antlr.org/grammar/ORACLE-7-SQL).

Note that it is not always necessary to use a parser to determine the dependencies of the object; this is only necessary when dependency information stored by the server itself is likely to be incorrect. In some cases (for example, table objects) relying on the information stored by the server may be accurate and parsing may not be necessary.

In an exemplary process according to the present invention the dependency information obtained by parsing the object scripts is then evaluated in order to determine which objects are dependent on no other objects (“phase 1”); which objects are dependent only on phase 1 objects (“phase 2”); which objects are dependent only on phase 2 objects or phase 2 objects and below (known as “phase 3” objects); and so on. In the context of the present invention, this process may be termed a ‘leaf pruning’ algorithm. Details of the “phase” of each object can then be used to specify an order, or sequence, in which each of the object scripts is to be run when it is required to create a script for either a whole database or a subset of the objects within a database. It is preferred that this ordering step is performed according to a suitable ‘leaf-pruning’-type algorithm, as described above.

As noted above, it is important that object scripts should be ordered correctly in the overall database script so that dependency information can be retained and the database server will be able to use the script to successfully recreate the database or subset of the database. Thus, phase 1 objects, which do not depend on any other objects, should have their object scripts placed in the database script so that they are executed before any phase 2 object scripts. Similarly, phase 2 object scripts should be ordered in the database script so that they are executed after phase 1 objects but before phase 3 objects, and so on.

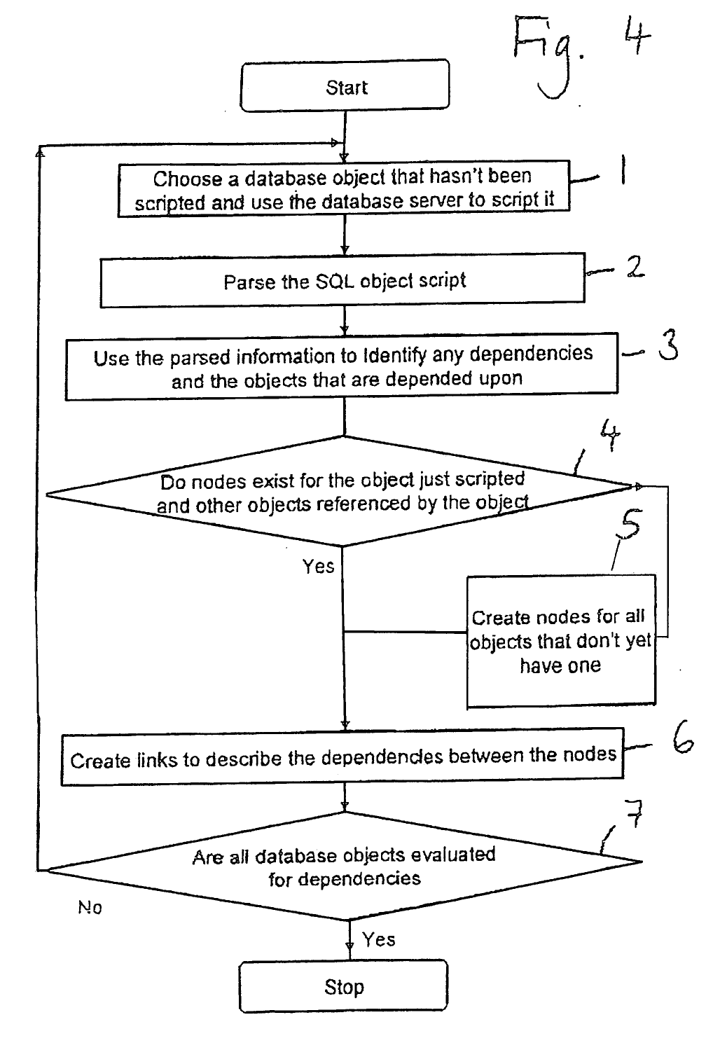

FIG. 4 shows a summary of a process in accordance with an embodiment of the present invention. This process involves creating a “tree structure” or node diagram representing dependency relationships between database objects. The process allows a series of individual objects scripts to be compiled in an appropriate order into a script for an entire database or a subset of a database such that when executed, the database script accurately reproduces the database or subset.

At step 1, an object in the database is selected for consideration. At step 2, a parsing operation is carried out on the selected object. At step 3, the parsed information is analysed to identify the dependency of the object, including details of the object(s) on which it depends.

At step 4, a determination is made of whether or not a nodes have already been created to represent the selected object and its dependencies in a node diagram. If not, a node is created (step 5). At step 6, links are created in the node diagram to represent the dependency information obtained in the parsing step. At step 7, a determination is made as to whether all database objects (or all objects within a desired subset) have been analysed, and if not, steps 1 to 6 are repeated for a further object.

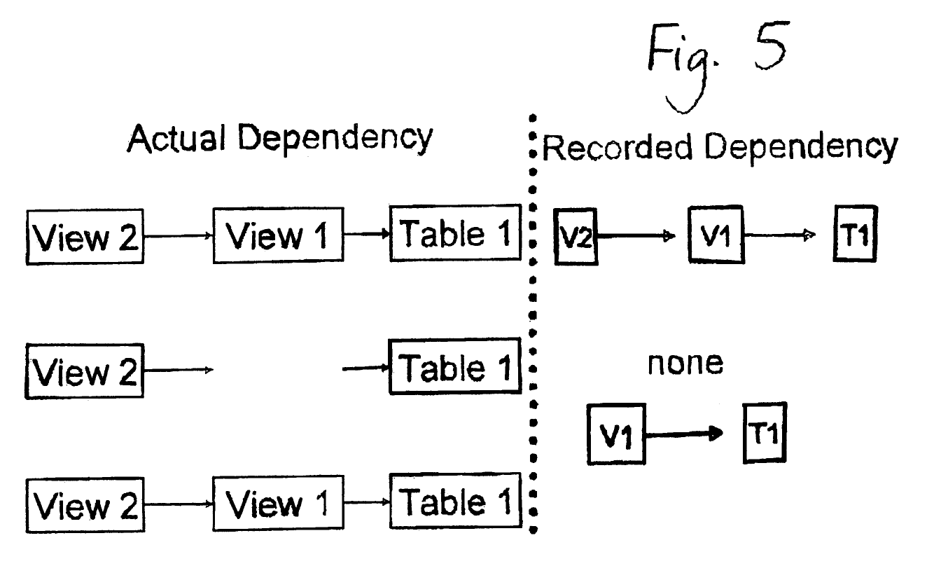

In contrast to the process of FIG. 4, the following method is typically used to order object scripts when compiling a database script in a Microsoft SQL server. The process it uses can be summarised as follows:
1. An SQL command is executed that creates or changes an object with dependencies.
2. At the time the database server executes the object script the dependency changes to the objects concerned are stored in a location specially designed by the database server.
3. If a database script is required the object scripts are-ordered using the dependency information stored at the time of the objects' creation.
   This known approach can have a flaw which is best illustrated using an example. FIG. 5 shows the actual dependency relationships of a subset of objects in a database compared with the dependency information stored by the Microsoft SQL server.

In the first row of FIG. 5, a series of objects is shown, in conjunction with their actual dependencies, in the left column. View 2 depends on View 1 which in turn depends on Table1. The right column represents the dependency information stored by the server, and shows that the information is correct and complete. V2 is known to be dependent on V1, which is known to be dependent on T1.

In the second row, the deletion of View 1 is represented. The script defining View 1 has been deleted from the database structure, and the stored dependency information is updated. There is now no dependency information stored at the server concerning the three objects in the example, since View 2 now depends on a non-existent object and Table1 does not have any objects dependent upon it.

In the third row, a new object called “View 1” is created, and its dependency is the same as that of the previous View 1: it depends on Table1, and View 2 is dependent upon it. The dependency information stored at the server is again updated, and because the script defining View 1 contains a reference to Table1, the server knows that View 1 depends on Table1. However, the server cannot recognise that View 2 is dependent upon the new View 1 because View 1's script does not refer to View 2. View 2 does refer to View 1, but when the original View 1 was deleted the stored dependency information was updated to reflect that View 2 was no longer dependent on View 1, and as View 2's script has not itself changed, the stored information will not be updated to include View 2's dependency on new View 1.

Thus, in a set of objects that are dependent on each other, if an object at the start of the dependency chain is deleted from the database and then recreated, some of the dependency information will be lost from the database server.

The following is a specific illustration of the type of problem that can occur in prior methods for calculating a sequence for executing object scripts. This example is based on a Microsoft SQL server database.

1. A first object, Table1, is created using appropriate SQL code:

CREATE TABLE Table1 (field1 int)
GO

2. A second object, View 1, is created:

CREATE VIEW View1 AS
SELECT * FROM Table1
GO

View1 depends on (i.e. relies on information within) Tablel. The server stores this information as metadata:

| Object | Dependent object |
|---|---|
| View1 | Table1 |

3. A third object, View2, is created:

CREATE VIEW View2 AS
SELECT * FROM View1
GO

The metadata is updated:

| Object | Dependent object |
|---|---|
| View1 | Table1 |
| View2 | View1 |

4. The object View1 is then deleted:

DROP VIEW View1
GO

Following the deletion of View1, the metadata table will be empty. This is because each record within the table previously included a reference to View1 and each of those records is now meaningless. The object View2 still exists in the database but it will not function because the objects it depends upon (i.e. View1 directly and Table1 indirectly) have been deleted from the dependency information stored in the server.

5. A new object, also called View1, is created:

CREATE VIEW View1 AS
SELECT * FROM Table1
GO

The metadata is now as follows:

| Object | Dependent object |
|---|---|
| View1 | Table1 |

Thus, although the new View1 is represented as depending correctly on Table1, the dependency of View2 on View1 is not shown because this information is not included in the script for View1, and the sysdepends table (metadata) is updated only with the dependency details of the new1y added object, and not with details of the dependency of old objects on the new object.

In accordance with embodiments of the present invention, once all object scripts have been parsed, the details of the phase of each object are evaluated in order to determine an appropriate order for executing the object scripts such that dependencies are preserved.

By using embodiments of the present invention, the disadvantages associated with lost or incorrect dependency information stored in prior systems can be avoided: This is because the stored dependency information within a database is not relied upon, but rather the scripts defining individual objects.

Considering FIG. 1, an example of the implementation of the present invention will be discussed. in detail. The script of each object A to O is parsed. The dependency information is calculated and preferably a node diagram is created.

FIG. 1A highlights those objects which do not depend on any other objects: J, L, N, O. These are referred to as phase 1 objects.

FIG. 1B highlights the object which depends only on phase 1 objects: object M. Object M is referred to as a phase 2 object.

FIG. 1C highlights the object which depends only on first and second phase objects: object K. This is referred to as a phase 3 object.

FIG. 1D highlights those objects which depend only on phase 1, 2 and 3 objects: objects G and I. These are referred to as phase 4 objects.

FIG. 1E highlights the object which depends only on phase 1, 2, 3 and 4 objects: object H. This is referred to as a phase 5 object.

FIG. 1F highlight those objects which depend only on phase 1 to 5 objects: object E and F. These are referred to as phase 6 objects.

FIG. 1G highlights all remaining objects, which depend only on phase 1 to 6 objects: objects A, B, C and D. These are referred to as phase 7 objects.

In the case of a larger or more complex database containing more objects, the above procedure should be continued until the phase of all objects has been identified. Once this has been done, an order in which the object scripts should be executed can be calculated by examining the node diagram. Object scripts should be presented to the database server in the order of their phases 1, 2, 3, . . . N, as determined by examining the node diagram.

It should be noted that it is not always necessary for the parsing operations of the present invention (step 2 of FIG. 4) to take place. In some cases, it may be that the dependency information stored by the server is accurate and complete, and in those cases parsing would not be necessary. However, if many modifications have been made to a database, or if for some other reason it is likely that the stored information is inadequate, parsing should be carried out.

The Microsoft SQL server example discussed above will now be considered in conjunction with an embodiment of the present invention. The sequence of steps 1-5 above are carried out so that the following objects exist in the database: Table1, View1 and View2. The scripts defining these objects are:

CREATE TABLE Table1 (field1 int)
GO
CREATE VIEW View1 AS
SELECT * FROM Table1
GO
CREATE VIEW View2 AS
SELECT * FROM View1
GO

At this stage, the existing dependency information stored by the server may not be correct (see step 5 above).

6. The scripts defining the objects are parsed and the dependency information specified in the scripts is extracted. The script defining Table1 indicates that Table1 is not dependent on any other objects. The script defining View1 indicates that it is dependent on Table1. The script defining View2 indicates that it is dependent on View1. The following shows schematically the parsing process whereby the language of the script defining View1 is considered, and the objects included within the script are identified in order that the dependency information can be extracted:

CREATE VIEW [View1] As
SELECT * FROM [Table1]
GO

The square brackets indicate the identified objects within the script. The parsing step analyses the language of the code surrounding the objects so that the dependencies represented by the code can be identified.
7. The dependency information generated from the parsing step 6 is then analysed. Preferably, a node diagram is created, and this may then be used to determine the phase of each object. In this example, Table1 can be seen not to depend on any other objects. It is therefore a phase 1 object. View1 can be seen to depend only on Table1, which is a phase 1 object. View1 is therefore phase 2. View2 can be seen to depend only on View1 which is a phase 2 object. View2 is therefore phase 3.
8. The phase information gathered in step 7 can then be used to determine a sequence in which the objects should be scripted. This step can optionally involve creating a node diagram as discussed above. The first phase of scripting should include all phase 1 objects (in this case, Table1); the second phase of scripting should include all phase 2 objects (in this case, View1); the third phase of scripting should include all phase 3 objects (in this case, View2).
9. The scripts are presented to the database server in the order described and will result in the database being correctly recreated.

It will be understood that the above examples are simplistic but that the principles of the present invention can be applied to much more complex arrangements of objects.

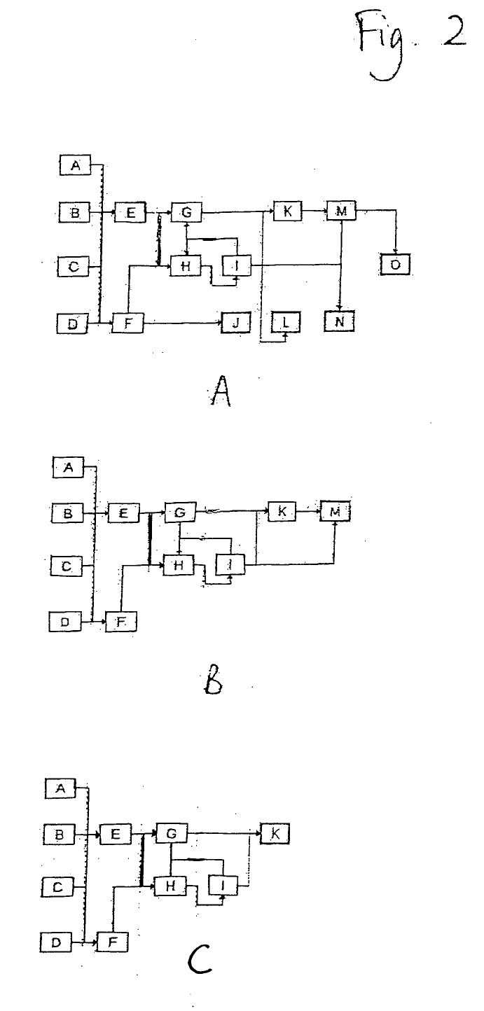

Considering now FIG. 2, the phase 1, phase 2 and phase 3 objects are highlighted in FIGS. 2A, 2B and 2C, as shown in FIGS. 1A to C; however, FIG. 2 illustrates a circularity within the dependency information of objects A to O. It can be seen that a complication will arise once phase 4 objects are to be considered. This is because object I depends on object H, which in turn depends on object I.

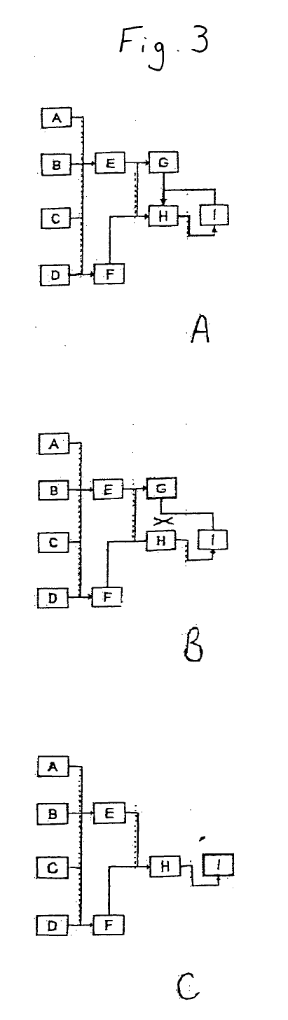

FIG. 3 illustrates an embodiment of the present invention in which the problem of circularities can be straightforwardly overcome. FIG. 3A indicates the I/H circularity. In accordance with an embodiment of the present invention, one of the dependencies between I and H is to be removed until the circularity no longer exists. More generally, a dependency should be removed from an object that only depends on other objects within the circularity, or a dependency should be removed from a circularity object that has the minimum number of non-circularity objects depending upon it. In the present case, the only object depending on I is object H, while objects I, E and F all depend on object H. Thus, the dependency from I to H should be removed as this will have the least impact on the overall dependency between the objects. On the other hand, if the dependency from H to I were removed, this would impact on objects E and F, which are indirectly dependent on object I via object H, and also objects A to D which are indirectly dependent on I. In general, if a circularity is complex, dependencies should be removed one at a time until the circularity has been removed, each time the dependency having least impact being removed.

Considering FIG. 3B, the cross indicates that the I to H dependency has been removed, such that I is now dependent only on G. The phase allocation can now continue. This will allow the database eventually to be re-created, whilst minimising the detriment to its structure.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

We claim:

1. A method of ordering a plurality of database object scripts, the method comprising the steps of:
parsing the plurality of object scripts to obtain dependency information representing dependencies between the object scripts; and
analysing the dependency information to determine a sequence in which to execute the object scripts.

2. A method according to claim 1, wherein the analysing step comprises creating a node diagram representing the dependency information.

3. A method according to claim 2, wherein the sequence in which to execute the object scripts is determined by applying a leaf pruning algorithm to the node diagram.

4. A method according to claim 3, wherein the leaf pruning algorithm is employed to assign a phase to each object script.

5. A method according to claim 4, wherein the phase for each object script is used to determine the sequence in which to execute the object script.

6. A method according to any preceding claim, wherein object scripts defining objects which have no dependency on other objects are sequenced such that they are executed first.

7. A method of ordering a plurality of database object scripts, the method comprising the steps of:
parsing the plurality of object scripts to obtain dependency information;
analysing the dependency information to determine a sequence in which to execute the object scripts;
creating a node diagram representing the dependency information;
analysing the node diagram using a leaf pruning algorithm to determine a phase for each object script; and
determining from the phase of each object script a sequence in which to execute the object scripts.

8. A method according to claim 7, wherein object scripts defining objects which have no dependency on other objects are sequenced such that they are executed first.

9. A method according to claim 7, further comprising the step of:
determining if a circularity exists in the dependency information;
ascertaining which of the objects involved in the circularity has the fewest dependencies on objects outside the circularity; and
removing the dependency of that object within the circularity.

10. A method for creating a database, comprising:
ordering a plurality of database object scripts into a determined sequence by parsing the plurality of object scripts to obtain dependency information between the object scripts;
analysing the dependency information to determine a sequence in which to execute the object scripts; and
executing the object scripts in the determined sequence to create a database.

11. A method according to claim 10, wherein the analysing step comprises creating a node diagram representing the dependency information.

12. A method according to claim 11, wherein the sequence in which to execute the object scripts is determined by applying a leaf pruning algorithm to the node diagram.

13. A method according to claim 12, wherein the leaf pruning algorithm is employed to assign a phase to each object script.

14. A method according to claim 13, wherein the phase for each object script is used to determine the sequence in which to execute the object script.

15. A method according to claim 14, wherein object scripts defining objects which have no dependency on other objects are sequenced such that they are executed first.

16. A method according to claim 14, further comprising the steps of:
determining if a circularity exists in the dependency information;
ascertaining which of the objects involved in the circularity has the fewest dependencies on objects outside the circularity; and
removing the dependency of that object within the circularity.
